(19) United States
(12) Patent Application Publication
(10) Pub. No.: US 2008/0280104 A1
(43) Pub. Date: Nov. 13, 2008

(54) Silicon-carbide nanostructure and method for producing the silicon-carbide nanostructure

(76) Inventors: Kentaro Komori, Saitama (JP); Satoshi Yoshida, Saitama (JP); Kazumi Ogawa, Saitama (JP)

Correspondence Address: ARENT FOX LLP, 1050 CONNECTICUT AVENUE, N.W., SUITE 400, WASHINGTON, DC, 20036, US

(21) Appl. No.: 11/978,559

(22) Filed: Oct. 30, 2007

(30) Foreign Application Priority Data
Nov. 16, 2006 (JP) 2006-310037

(51) Int. Cl. B32B 5/16; H01B 1/04

(52) U.S. Cl. 428/149; 428/402; 252/516; 977/814

(57) ABSTRACT

A method for producing a silicon-carbide nanostructure, which includes steps of: irradiating a carbon-source supplied to a reaction chamber at a pressure of 1. Pa to 70 Pa with microwaves of 0.5 kW to 3 kW; generating plasma in a space above the silicon substrate at a temperature of 350° C. to 600° C.; and forming a silicon-carbide nanostructure having cone-shaped silicon-carbide aggregates which are scattered on and protruded from a surface of a silicon substrate. The silicon-carbide aggregates have a crystal structure of 2H α-siC.

### CROSS REFERENCE TO RELATED APPLICATIONS

This application claims the foreign priority benefit under Title 35, United States Code, §119(a)-(d) of Japanese Patent Application No. 2006-310037, filed on Nov. 16, 2006, the contents of which are hereby incorporated by reference.

### BACKGROUND OF THE INVENTION

1. Field of the Invention

The present invention relates to a new silicon-carbide nanostructure which has a cone-shaped protrusion and a method for producing the new silicon-carbide nanostructure.

2. Description of Related Art

Silicon-carbide (hereinafter, referred to as SiC) has a wide energy band gap and a high thermal stability compared with, for example, Si and GaAs which have already been put to practical use in semiconductor devices. Therefore, SiC is expected as a semiconductor material for fabricating a high-power device under a high temperature environment, for example, in vehicles. SiC has a crystal structure in which a silicon layer and a carbon layer form various types of double-layers, that is, so-called polytype which has several hundred types of double layers depending on a type of the double-layer. 3C-SiC, 2H-SiC, and 4H-SiC are typical crystal structures of -the polytype. The 2H-SiC has the widest energy band gap (3.33 eV). The 4H-SiC has a little narrower energy band gap (3.27 eV) than that of the 2H-SiC. However, the 4H-SiC has an advantage that a large single crystal can be grown.

In addition, SiC has a high hardness. Therefore, SiC has been partially put in practical use as a friction material having an excellent abrasion resistance or as an additive of the friction material, or as a coating material. A morphology control is required for SiC as well as a structural control. Specifically, for example, conical-shaped morphology and needle-like morphology may be utilized for improving an electron emission characteristic and abrasion resistance.

In a production of SiC described above, a temperature of not less than 1000° C. to 1500° C. is generally required for producing a bulk SiC or a thin film SiC. For example, a method for producing a crystalline thin film SiC is described in a non-patent literature, “Development of polytype control technology for crystalline thin film SiC” (Polytype Control of SiC Heteroepitaxial Film by Pulsed-Laser Deposition) , AIST Today, Vol.4-6, pl4, 2004/4 (public relations magazine of National Institute of Advanced Industrial Science and Technology), in which the crystalline thin film SiC is produced through deposition of SiC on a substrate at a temperature of 1100° C. by evaporating a SiC material source using a high-power ultraviolet pulse laser. In addition, a method for producing a silicon-carbide whisker (hereinafter, referred to as SIC whisker) is disclosed in Japanese Patent Laid-open Publication No. H03-51678, in which the SiC whisker is produced as follows. Silicon-dioxide and carbon-black are heated up together at a temperature between 1400° C. and 1700° C. under hydrogen ambient for causing a reaction of the carbon-black with hydrogen to generate hydrocarbons. The silicon-dioxide is reduced by the hydrocarbons to generate silicon monoxide. Then, the silicon monoxide is reacted with the carbon-black to produce the SiC whisker. However, as described above, a high temperature of not less than 1000° C. is required for the conventional production method of SiC. Therefore, development of a simple and low-temperature process is required for producing a low cost and highly versatile SiC as a material for, for example, automobile semiconductor devices and sliding coating materials.

In addition, SiC is required to control morphology as well as a crystal structure for improving functionality of the SiC as a material for electronic devices and sliding coating materials. For example, it is thought that SiC having conical-shaped protrusions and needle-like protrusions is effective for improving an electron emission characteristic and abrasion resistance property.

It is, therefore, objects of the present invention to provide a SiC nanostructure having cone-shaped morphology which is effective for improving an electron emission characteristic and abrasion resistance property, and to provide a method for producing the SiC nanostructure with a simple and low-temperature process.

### SUMMARY OF THE INVENTION

According to a first aspect of the present invention, there is provided a silicon-carbide (hereinafter, referred to as SiC) nanostructure having cone-shaped SiC aggregates which are scattered on and protruded from a surface of a silicon (hereinafter, referred to as Si) substrate.

The SiC nanostructure described above is expected to have an improved electron emission characteristic and abrasion resistance property since the cone-shaped SiC aggregates are scattered on and protruded from the surface of the Si substrate.

According to a second aspect of the present invention, there is provided a SiC nanostructure of the first aspect, wherein the SiC aggregates are formed in substantially a cone shape having a height of 50 nm to 500 nm and a bottom diameter of 10 nm to 200 nm.

The SiC nanostructure described above is expected to have an improved electron emission characteristic and abrasion resistance property since the SiC nanostructure has morphology in which the cone-shaped SiC aggregates, which are formed in substantially the cone shape having the height of 50 nm to 500 nm and the bottom diameter of 10 nm to 200 nm, are scattered on and protruded from the surface of the Si substrate.

According to a third aspect of the present invention, there is provided a SiC nanostructure of the first or the second aspect, wherein the SiC aggregates have a crystal structure of 2H α-SiC.

The SiC nanostructure described above is promising as a material for high-power semiconductor devices since the SiC aggregates have the crystal structure of 2H α-SiC which has the widest energy band gap among several hundred types of crystal structures called polytype.

According to a fourth aspect of the present invention, there is provided a method for producing a SiC nanostructure, which includes steps of: irradiating a carbon-source supplied to a reaction chamber at a pressure of 1 Pa to 70 Pa with microwaves of 0.5 kW to 3 kW; generating plasma in a space above a Si substrate at a temperature of 350° C. to 600° C.; and forming a SiC nanostructure having cone-shaped SiC aggregates which are scattered on and protruded from a surface of the Si substrate.

By using the method for producing the SiC nanostructure described above, the SIC nanostructure which has new unique morphology, in which cone-shaped SiC aggregates are scattered on the surface of the Si substrate, can be produced at the low substrate -temperature of 350° C. to 600° C. with a simple production condition without catalyst by a microwave plasma CVD method.

According to a fifth aspect of the present invention, there is provided a method for producing a SiC nanostructure of the fourth aspect, wherein the carbon-source is a gas having 0.1% to 10% of carbon atoms.

By using the method for producing the SiC nanostructure described above, the SiC nanostructure which has new unique morphology, in which cone-shaped silicon-carbide aggregates are scattered on the surface of the Si substrate, can be produced at the low substrate temperature of 350° C. to 600° C. with a simple production condition without catalyst by supplying the gas having 0.1% to 10% of carbon atoms into a reaction chamber as a carbon-source.

According to a sixth aspect of the present invention, there is provided a method for producing a SiC nanostructure of the fourth or fifth aspect, wherein the carbon-source contains hydrogen and at least one carbon-containing compound selected from a group of hydrocarbons, CO₂ and CO.

By using the method for producing the SiC nanostructure described above, the SiC nanostructure which has new unique morphology, in which cone-shaped silicon-carbide aggregates are scattered on the surface of the Si substrate, can be produced at the low substrate temperature of 350° C. to 600° C. with a simple production condition without catalyst by supplying the carbon-source, which contains hydrogen and at least one carbon-containing compound selected from the group of hydrocarbons, CO₂ and CO, into the reaction chamber.

The inventions described in the first and the second aspects provides the SiC nanostructure which has new morphology having the cone-shaped SiC aggregates which are scattered on and protruded from the surface of the silicon substrate. The SiC nanostructure has unique morphology having a cone-shaped bamboo shape or a needle-like shape and has a wide energy band gap and excellent thermal stability. Therefore, the SiC nanostructure is expected to have an improved electron emission characteristic and abrasion resistance property. The SiC nanostructure is expected to be applied to various kinds of electronic devices, for example, a high-power semiconductor device such as a schottky barrier diode and a static induction transistor, a light-emitting device which utilizes the electron emission characteristic, an electron emission element for a field emission display (FED), a thyristor for power conversion, railways, automobiles, and electric home appliances, a motor control module, and a switching element. In addition, since there exist the cone-shaped SiC aggregates being scattered among spaces, while the SiC nanostructure keeping mechanical properties of high hardness and high friction, the SiC nanostructure is expected to have an excellent lubrication oil holding characteristic by forming oil pools among the cone-shaped SiC aggregates when the SiC nanostructure is applied to a friction sliding member or a coating material of the friction sliding member, or applied to a surface modification material.

The invention described in the third aspect provides the SiC nanostructure having the crystal structure of 2H α-SiC. Since the crystal structure of the 2H α-SiC has a wide energy band gap, the SiC nanostructure is promising as a material for high-power semiconductor devices, which utilize the wide energy band gap.

The inventions described in the fourth to sixth aspects provides the methods with which the SiC nanostructure having new unique morphology, in which the cone-shaped silicon-carbide aggregates are scattered on the surface of the Si substrate, can be produced at the low substrate temperature of 350° C. to 600° C. with a simple production condition without catalyst.

### BRIEF DESCRIPTION OF THE DRAWINGS

FIG. 1A is a scanning electron micrograph showing a typical example of a SiC nanostructure according to the present invention;

FIG. 1B is a schematic illustration roughly showing a cross section of the SiC nanostructure;

FIG. 2 is a schematic illustration showing a microwave plasma CVD apparatus;

FIG. 3A is a scanning electron micrograph of a SiC nanostructure which is obtained in an embodiment 1;

FIG. 3B is a scanning electron micrograph of a SiC nanostructure which is obtained in embodiments 2 and 3;

FIG. 4A is a scanning electron micrograph of a thin film which is obtained in comparative examples 2 and 3;

FIG. 4B is a scanning electron micrograph of a thin film which is obtained in comparative examples 4 and 5;

FIG. 5 is a scanning electron micrograph of a cross section of a SiC nanostructure which is obtained in embodiments 2 and 3;

FIG. 6A is a selected-area electron diffraction pattern of a Si substrate portion; and

FIG. 6B is a selected-area electron diffraction pattern of a SiC nano-bamboo portion.

### DETAILED DESCRIPTION OF THE PREFERRED EMBODIMENT

Hereinafter, embodiments of the present invention will be explained in detail by referring to drawings.

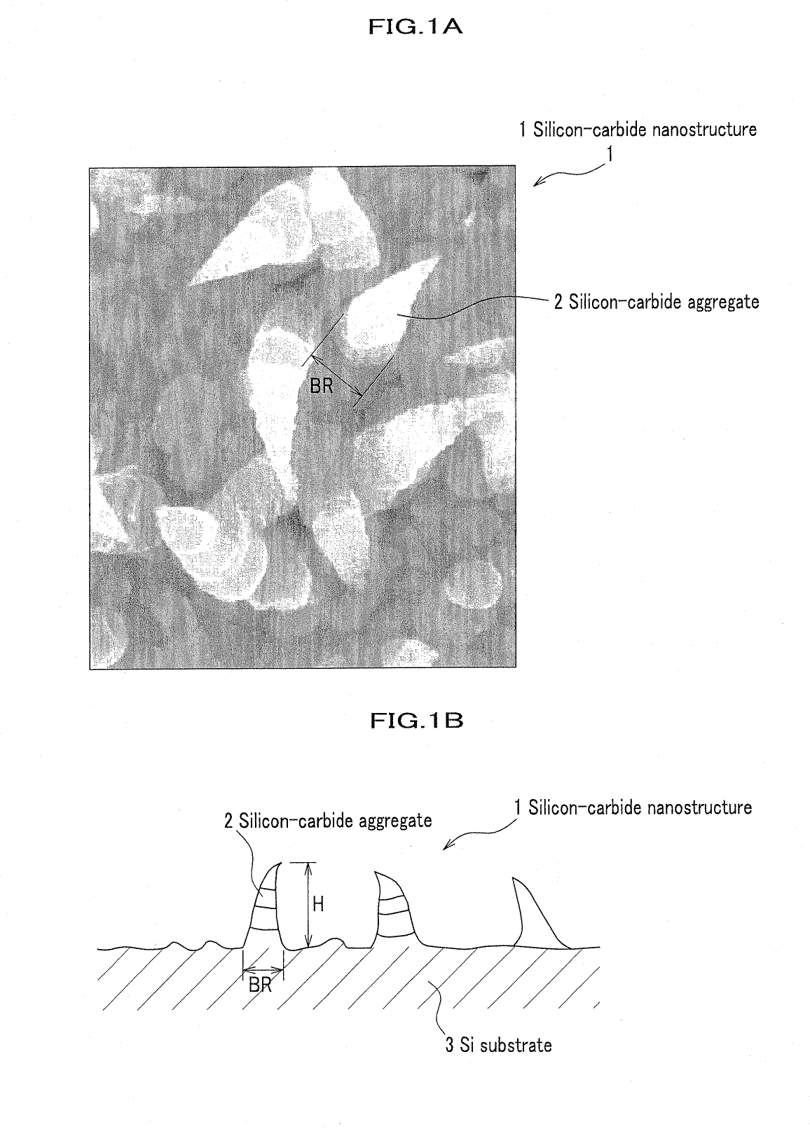

FIG. 1A is an example of a scanning electron micrograph of a silicon-carbide (hereinafter, referred to as SiC) nanostructure according to the present invention. FIG. 1B is a schematic illustration showing a cross sectional structure of the SiC nanostructure.

As shown in FIG. 1A and FIG. 1B, the SiC nanostructure 1 according to the present invention has morphology in which a SiC aggregate 2 (hereinafter, referred to as SiC nano-bamboo) having approximately a nanosized cone shape is grown and scattered on a surface of a Si substrate 3. In the SiC nanostructure 1, as schematically shown in FIG. 1B, the SiC nano-bamboo 2 has substantially a cone shape, that is, a bamboo shape or a needle-like shape having a height of 50 nm to 500 nm and a bottom diameter BR of 10 nm to 200 nm, and the SiC nano-bamboo 2 is scattered on the surface of the Si substrate 3 with a surface density of about 30 pieces/μm² to 100 pieces/μm². In addition, a remaining space except for the areas of the SiC nano-bamboos 2, 2, . . . , is occupied by still-growing SIC nano-bamboos 2, 2, . . . , and the surface of the Si substrate 3.

The SiC nano-bamboo 2 has a crystal structure, so-called polytype which has several hundred types of crystal structures. The SiC nano-bamboo 2 having a crystal structure of -SiC, which has the widest energy band gap, is promising as a material for high-power devices. A crystal structure of the SiC nano-bamboo can be controlled by production conditions of the SiC structure.

Next, a method for producing the SiC nanostructure according to the present invention will be explained.

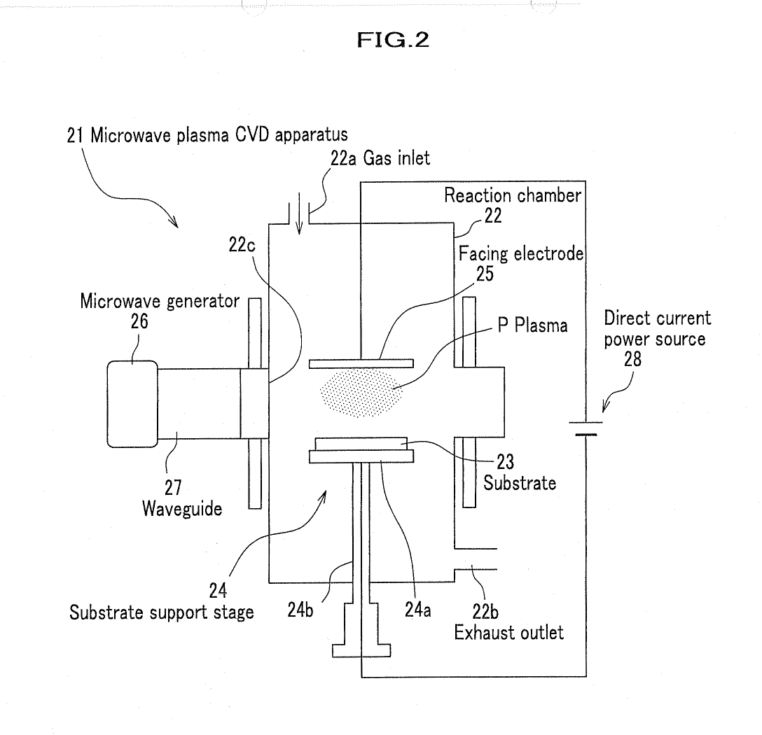

FIG. 2 is a schematic illustration showing a brief constitution of a microwave plasma CVD apparatus which is used for producing the SiC nanostructure.

The microwave plasma CVD apparatus 21 includes a reaction chamber 22, a substrate support stage 24 for supporting a substrate 23 to be arranged in the reaction chamber 22, a facing electrode 25 to be arranged facing the substrate 23, and a waveguide 27 for guiding microwaves into the reaction chamber 22. The microwaves are generated by a microwave generator 26 which is disposed outside the reaction chamber 22.

The reaction chamber 22 includes a gas inlet 22 a for introducing a carbon source gas into an upper portion of the reaction chamber 22 and an exhaust outlet 22b in a lower portion of the reaction chamber 22. The reaction chamber 22 is communicated with the waveguide 27 through a microwave inlet 22c. An ambient pressure of the reaction chamber 22 is controlled to a predetermined value by evacuating a gas from the reaction chamber 22 by a vacuum pump (not shown) which is connected to the exhaust outlet 22b.

The substrate support stage 24 includes a flat base 24 a made of electrical conductive materials such as graphite and stainless steel and a support rod 24b for supporting a bottom of the flat base 24a. In addition, the substrate support stage 24 has a heating means (not shown) for heating up the substrate 23 placed on the flat base 24 a at a predetermined temperature. Further, in connection with the substrate support stage 24, the facing electrode 25 is connected to a positive electrode of a direct current power source 28 and the flat base 24 a is connected to a negative electrode of the power source 28 so as to apply a direct current bias voltage between the facing electrode 25 and the substrate 23.

The waveguide 7 introduces microwaves generated by the microwave generator 26 into the reaction chamber 22 through the microwave inlet 22c. The microwaves introduced into the reaction chamber 22 excite H2 and carbon compounds in a carbon-source gas, which is supplied to a space between the facing electrode 25 and the substrate 23 through the gas inlet 22a, to generate plasma.

A production of the SiC nanostructure using the microwave plasma CVD apparatus 21 is conducted by the following processes.

(1) First, the substrate 23 made of Si, whose surface is cleaned up, is placed on an upper surface of the flat base 24 a of the substrate support stage 24, then, an ambient gas is evacuated from the reaction chamber 22 by operating a vacuum pump connected to the exhaust outlet 22b.
(2) Next, a carbon-source gas is introduced into the reaction chamber 22 from the gas inlet 22 a , while the substrate 23 is heated up. At this time, a direct current bias voltage V is applied between the substrate 23 and the facing electrode 25 by the direct current power source 28.
(3) Microwaves are generated by the microwave generator 26 and introduced into the reaction chamber 22 through the waveguide 27. The microwaves introduced into the reaction chamber 22 excite H₂ and carbon compounds in the carbon-source gas, which is supplied to the space between the facing electrode 25 and the substrate 23 through the gas inlet 22 a , to generate plasma P. The plasma P containing the excited H2 and carbon compounds react with Si which composes the substrate 23 to produce SiC. It is thought that the SiC bamboo, which has a unique shape, is formed by a deposition of the SiC on the substrate 23.

In the production method according to the present invention, a temperature (substrate temperature) of the substrate 23 is controlled between 350° C. and 600° C. If the substrate temperature (T) is lower than 350° C., an amorphous carbon, for example, DLC (Diamond-Like-Carbon) is formed on a surface of the substrate since the reaction with the substrate is not promoted. If the substrate -temperature (T) is higher than 600° C., an aggregate or a film of granular or plate-like carbonized particles is formed due to an excess thermal energy. An ambient pressure (P22) of the reaction chamber 22 is controlled between 1 Pa and 70 Pa. If the ambient pressure is lower than 1 Pa, the reaction with the substrate is not promoted, and the amorphous carbon, for example, DLC (Diamond-Like-Carbon) is formed on the surface of the substrate. If the ambient pressure is higher than 70 Pa, an aggregate or a film of granular or plate-like carbonized particles is formed. In this case, a ratio of the ambient pressure (P22) to the substrate temperature (T), that is, the ratio of P22/T effects on the reaction and diffusion of the carbon-source gas and substrate components, thereby the ratio has an important role for controlling a configuration and composition of the product. Therefore, it is preferable to control the ratio between 0.01 and 0.2.

In addition, a microwave output is controlled between 0.5 kW and 3 kW. If the microwave output is smaller than 0.5 kW, the reaction and diffusion of the carbon-source gas and substrate components become insufficient. If the microwave output is larger than 3 kW, a generation of a crystalline carbon component such as graphite is caused due to an excess energy supply. The microwaves may be generated by using a microwave generator having a frequency of 2.45 GHz.

A flow rate of the carbon-source gas to be supplied into the reaction chamber 22 from the gas inlet 22 a is usually controlled between 500 sccm and 1000 sccm. The carbon-source gas contains hydrogen and carbon-containing compounds and used for generating plasma P. It is preferable that the carbon-source gas contains 1% to 10% of carbon atoms. The carbon-containing compounds are at least one selected from a group of hydrocarbon, CO₂ and CO. The carbon-containing compounds may also be monomethyl silane (MMS) and tetramethyl silane (TMS), which are gases containing silicon and carbon. The hydrocarbon includes low hydrocarbons such as methane (CH₄), acetylene (C₂H₂) , and benzene (C₆H₆) . In the low hydrocarbons described above, methane (CH₄), which has a lower ratio of carbon atom to hydrogen atom in the CH₄ molecule, is preferable for suppressing an excess supply of carbon atoms. It is also preferable that a flow rate ratio of the carbon-containing gas to hydrogen gas in the carbon-source gas is controlled between 0.001 and 0.1. In addition, the carbon-source gas may contain inert gases such as He, Ar, Xe, and Kr.

The direct current bias voltage to be applied between the substrate 23 and the facing electrode 25 is usually controlled between tens of volts and 1000 volts.

### EMBODIMENT

Hereinafter, the present invention will be specifically explained in detail by using embodiments and comparative examples according to the present invention. However, the present invention is not limited to the following embodiments. (Embodiments 1 to 3, Comparative examples 1 to 5) The SiC nanostructure was produced by using the microwave plasma CVD apparatus 21 briefly shown in FIG. 2. As the Si substrate 23, a square silicon wafer having a thickness of 0.6 mm and sides of 10 mm to 15 mm was prepared. The silicon wafer was placed on the upper surface of the flat base 24a of the substrate support stage 24 which is arranged inside the reaction chamber 22, then, a pressure inside the reaction chamber 22 was reduced to not more than 10-3 Pa. A temperature (substrate temperature: ° C.) of the Si substrate 23, a microwave output (kW) to be introduced into the reaction chamber 22 through the waveguide 27, a composition of the carbon-source gas to be supplied to the reaction chamber 22 from the gas inlet 22 a , a direct current bias voltage (V) to be applied between the facing electrode 25 and the silicon substrate 23 by the direct current power source 28, and an ambient pressure (Pa) inside the reaction chamber 22 were varied as shown in Table 1 for producing the SiC nanostructure by the microwave plasma CVD method. In this case, a flow rate of the carbon-source gas to be supplied to the reaction chamber 22 from the gas inlet 22 a was controlled between 500 sccm and 1000 sccm.

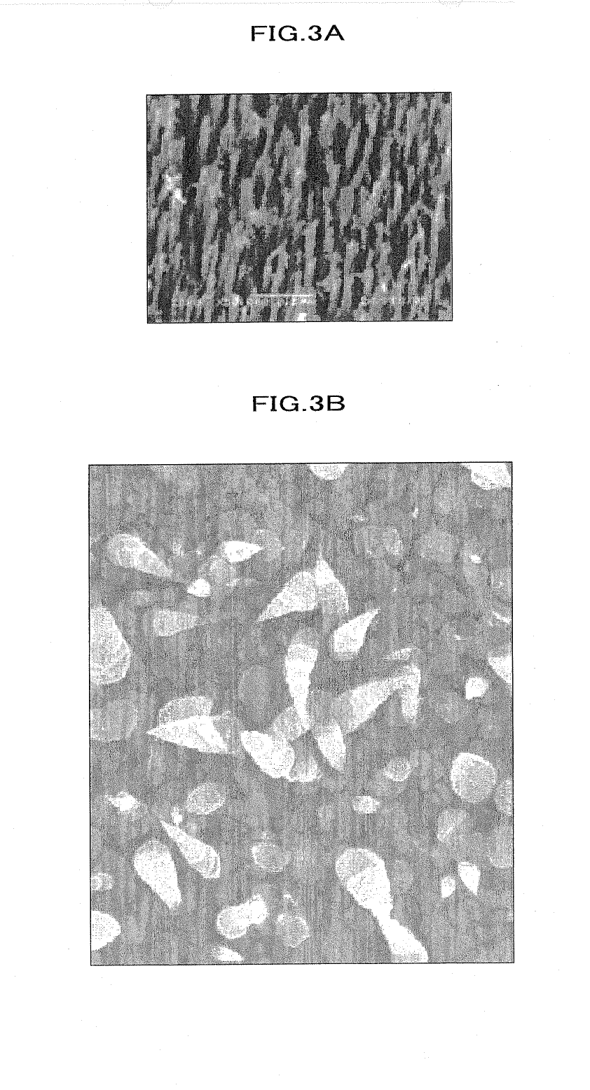

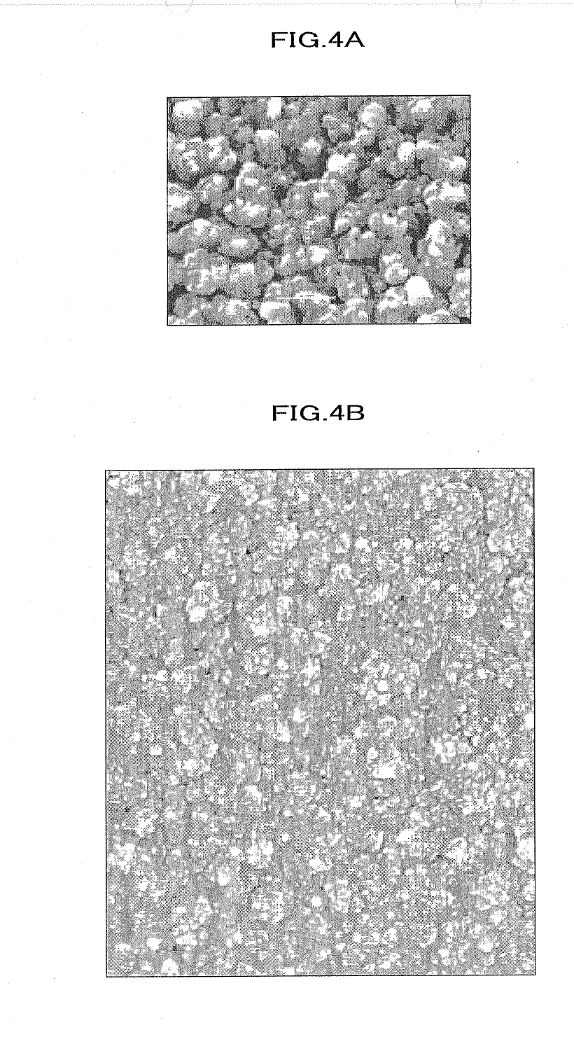

TABLE 1

| | | Flow | | | | |
|---|---|---|---|---|---|---|
| | Microwave | rate of | | | | |
| | output for | carbon | | | | Morphology |
| Embodiment or | plasma | source | DC-bias | Ambient | Sub. | of |
| Comparative | generation | gas | voltage | press. | Temp. | Si-substrate |
| example | (W) | (sccm) | (V) | (Pa) | (° C.) | surface |
| Comp. | 2500 | H₂:500, | +50 | 61 | 480 | granular |
| ex. 1 | | CH₄:2.5 | | | | |
| Emb. 1 | 2400 | H₂:500, | +700 | 60 | 380 | needle-like, |
| | | CH₄:2 | | | | FIG. 3A |
| Emb. 2 | 2000 | H₂:500, | +100 | 5.6 | 490 | needle-like |
| | | CH₄:5, | | | | (thick), |
| | | Ar:20 | | | | FIG. 3B |
| Emb. 3 | 2300 | H₂:500, | +20 | 5.7 | 480 | FIG. 3B |
| | | CH₄: 2.5 | | | | |
| Comp. | 2400 | H₂:500, | +200 | 79 | 400 | granular, |
| ex. 2 | | He:200, | | | | FIG. 4A |
| | | CO:2 | | | | |
| Comp. | 2400 | H₂:400, | 0 | 91 | 490 | Plate-like/ |
| ex. 3 | | He:200, | | | | granular, |
| | | CH₄:1, | | | | FIG. 4A |
| | | CO:1 | | | | |
| Comp. | 2000 | H₂:90, | 0 | 40 | 240 | island-shape/ |
| ex. 4 | | CH₄:10 | | | | granular, |
| | | | | | | FIG. 4B |
| Comp. | 1000 | H₂:1000, | 0 | 40 | 240 | coarse |
| ex. 5 | | TMS:2 | | | | granular, |
| | | | | | | FIG. 4B |

TMS: Tetramethyl silane

Next, a scanning electron micrograph of a surface of the Si substrate was taken.

FIG. 3A shows a scanning electron micrograph (magnification ratio: 50000) of the SiC nanostructure obtained in the embodiment 1. FIG. 3B shows a scanning electron micrograph (magnification ratio: 50000) of the SiC nanostructure obtained in the embodiments 2 and 3.

FIG. 4A shows a scanning electron micrograph (magnification ratio: 50000) of the thin film on the Si substrate obtained in the comparative examples 2 and 3. FIG. 4B shows a scanning electron micrograph (magnification ratio: 100000) of the thin film on the Si substrate obtained in the comparative examples 4 and 5.

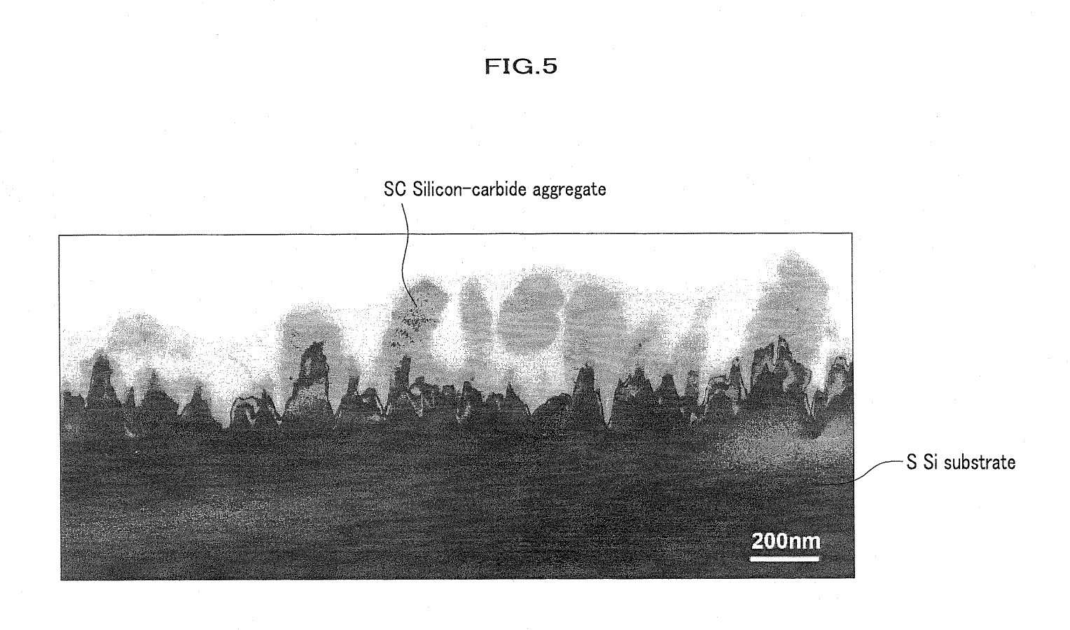

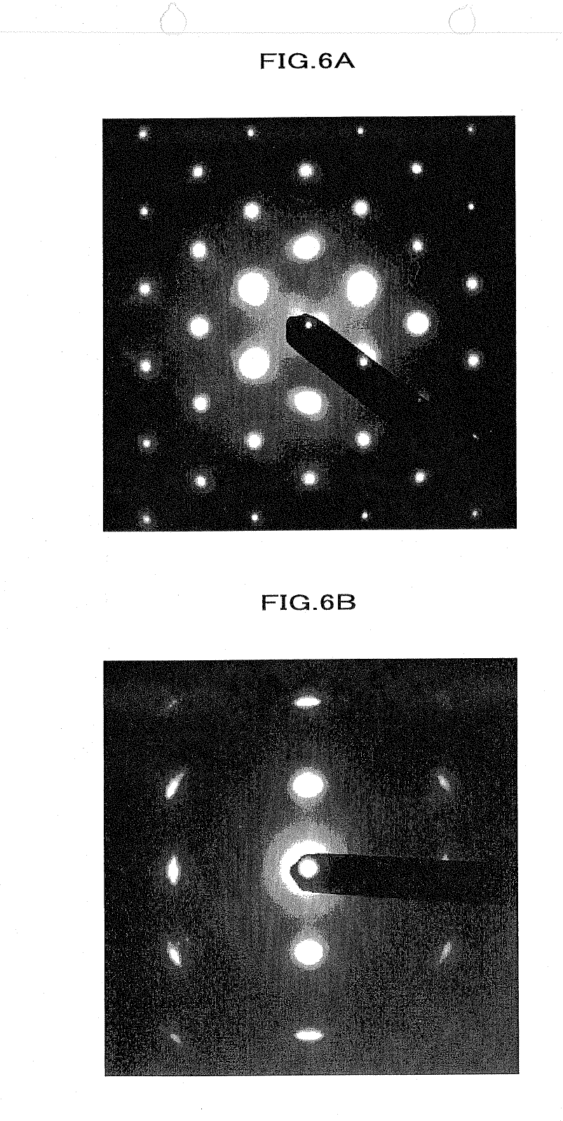

In addition, section samples of the SiC nanostructures, which were obtained in the embodiments 2 and 3, were prepared and selected-area electron diffraction patterns of the Si substrate and the SiC nano-bamboo, as well as cross sectional micrographs of the SiC nanostructure were taken by a scanning electron microscope. FIG. 5 shows a transmission electron micrograph of a SiC nanostructure cross section. FIG. 6A shows a selected-area electron diffraction pattern in S portion of the Si substrate shown in FIG. 5. FIG. 6B shows a selected-area electron diffraction pattern of the SiC nano-bamboo SC which is protruded from the surface of the Si substrate shown in FIG. 5. From FIG. 6A and FIG. 6B, it has been found that the SiC nanostructures obtained in the embodiments 2 and 3 have the morphology in which cone-shaped SiC nano-bamboos having the crystal structure of 2H α-SiC are protruded from the surface of the Si substrate.

What is claimed is:

1. A silicon-carbide nanostructure having cone-shaped silicon-carbide aggregates which are scattered on and protruded from a surface of a silicon substrate.

2. The silicon-carbide nanostructure according to claim 1, wherein the cone-shaped silicon-carbide aggregates are formed in substantially a cone shape having a height of 50 nm to 500 nm and a bottom diameter of 10 nm to 200 nm.

3. The silicon-carbide nanostructure according to claim 1,
wherein the cone-shaped silicon-carbide aggregates have a crystal structure of 2H α-SiC.

4. The silicon-carbide nanostructure according to claim 2,
wherein the cone-shaped silicon-carbide aggregates have a crystal structure of 2H α-SiC.

5. A method for producing a silicon-carbide nanostructure, comprising steps of:
irradiating a carbon-source supplied to a reaction chamber at a pressure of 1 Pa to 70 Pa with microwaves of 0.5 kW to 3 kW;
generating plasma in a space above the silicon substrate at a temperature of 350° C. to 600° C.; and
forming a silicon-carbide nanostructure having cone-shaped silicon-carbide aggregates which are scattered on and protruded from a surface of a silicon substrate.

6. The method for producing a silicon-carbide nanostructure according to claim 5,
wherein the carbon-source is a gas having 0.1% to 10% of carbon atoms.

7. The method for producing a silicon-carbide nanostructure according to claim 5,
wherein the carbon-source contains hydrogen and at least one carbon-containing compound selected from a group of hydrocarbon, CO₂ and CO.

8. The method for producing a silicon-carbide nanostructure according to claim 6,
wherein the carbon-source contains hydrogen and at least one carbon-containing compound selected from a group of hydrocarbon, CO₂ and CO.
